(19) United States
(12) Patent Application Publication
(10) Pub. No.: US 2005/0209436 A1
(43) Pub. Date: Sep. 22, 2005

(54) Method and device for the continuous production of polyamide 6, 6 and copolyamides thereof

(76) Inventor: Karl-Heinz Wilzer, Bad Blakenburg (DE)

Correspondence Address: OSTROLENK FABER GERB & SOFFEN, 1180 AVENUE OF THE AMERICAS, NEW YORK, NY, 100368403, US

(21) Appl. No.: 10/509,134

(22) PCT Filed: Mar. 25, 2003
(86) PCT No.: PCT/EP03/03091

§ 371 Date: May 26, 2005

(30) Foreign Application Priority Data
Mar. 25, 2002 (DE) 102132631

(51) Int. Cl. C08G 69/26

(52) U.S. Cl. 528/335; 422/135

(57) ABSTRACT

A method and device for the continuous production of copolyamide and polyamide, the starting materials for which comprise hexamethylenediamine adipate (nylon salt), water and, in the case of copolyamide, additionally lactam, comprise a first method step (2) which is carried out under pressure at a temperature of between 180 and 280° C. After the pass through the first method step, the prepolymer is subjected to a second method step (5), from which the evaporated water is removed or driven off by inert gas. The water evaporated off in the first method step (2) with the reaction components contained therein is fed to the at least one further method step (5) and the water is only driven off in said method step or subsequent method steps.

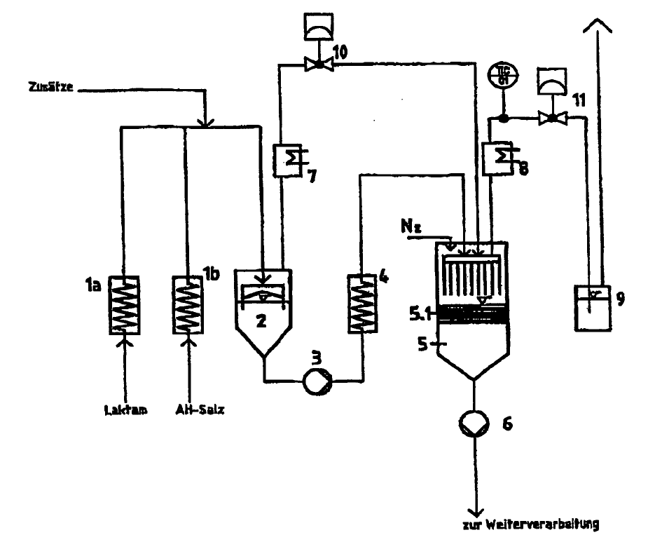

The invention relates to a method and a device for carrying out the method for the continuous production of copolyamide or polyamide of the type stated in the preamble of claim 1 and 6, respectively.

For the polymerization of the hexamethylenediamine salt of adipic acid (AH salt) or adipic acid and hexamethylenediamine, it is known that the starting material used is an aqueous AH salt solution which is heated in a pressure-resistant reactor to a temperature in the range of 220-280° C., with the aim of preparing an AH precondensate in which the NH₂ groups of the hexamethylenediamine are reacted with the COOH groups of the adipic acid.

It is known that the aqueous solution of the hexamethylenediamine salt of adipic acid is heated under a pressure which is lower than the vapor pressure generated by the solution, with simultaneous evaporation of the water, and the most readily volatile, expelled hexamethylenediamine is retained in a column and is recycled to the polymerization process (U.S. Pat. No. 2,689,839; U.S. Pat. No. 3,960,820). When such a precondensate is let down, a small amount of hexamethylenediamine may escape. For compensating the viscosity-lowering excess of acid, hexamethylenediamine is added in excess (U.S. Pat. No. 3,193,535; DE 2 417 003). Dewatering and postcondensation of the polyamide melt are carried out by known methods.

DE-A1 196 21 088 furthermore discloses that the complete conversion of the NH₂ groups of the hexamethylenediamine and of the COOH groups of the adipic acid can be achieved by a closed procedure of the first method stage in a polymerization reactor under the full pressure generated at the corresponding reaction temperature. Here, however, a part of the evaporating water has to be separated off at high pressure and high temperature in the polymerization reactor, which results in high energy consumption without it being possible completely to avoid diamine losses.

It was the object of the invention to provide a method and a device of the type stated at the outset, in which method and in which device the water can be separated off at relatively low temperatures and pressures and with reduced diamine losses.

This object is achieved by the features stated in patent claim 1 and 6, respectively.

Advantageous embodiments and further developments of the invention are evident from the respective subclaims.

In the method according to the invention and the device, the water evaporating in the first stage of the method, with reaction components contained therein, is passed into the at least one further stage of the method, and the expulsion of the water is effected only in the further stage or stages of the method.

In this way, the water can be separated off at relatively low temperatures and pressures and with reduced diamine losses.

The water evaporating in the first stage of the method, with reaction components contained therein, is preferably passed via a rectification method into the at least one further stage of the method.

A preferred technical solution for the rectification method comprises a reflux column.

Of the greatest importance when using rectification methods in the overall method is the use of reflux columns for those stages of the method from which water is released into the environment. The loss of reactive component is thus minimized to such an extent that there is no marked influence on the final viscosity of the polyamide.

In the method according to the invention, an amount of the AH salt of up to 30% or from 80 to 100% is preferably used.

The expulsion of the water in the reflux column can be effected at a temperature of less than 120° C., caprolactam and diamine fractions separated off in the reflux column being recycled to the at least one further stage of the method.

The device according to the invention has a first pressure reactor, upstream of which a heat exchanger is connected and downstream of which at least one postcondensation reactor is connected via a melt dryer, the gas space of the pressure reactor being connected with pressure control to the gas space of the postcondensation reactor, and water from the gas space of the postcondensation reactor is expelled via a reflux column and a trap.

The caprolactam and diamine fractions separated off in the reflux column are recycled to the postcondensation reactor.

The separation in the reflux column can be effected at a temperature of less than 120° C.

The invention is explained in more detail below with reference to working examples and to an embodiment of the device shown in the drawing.

The drawing shows, in a schematic diagram, the arrangement according to the invention of the stages of the method for the continuous production of copolyamide.

A plant for the production of polyamide from aqueous AH salt without addition of caprolactam, optionally also with additions of stabilizer, such as, for example, propionic acid, differs from the device according to the embodiment shown in this drawing only in that no lactam is metered, the preheater is out of operation and there is the possibility of controlling the pressure also after the reflux column.

### WORKING EXAMPLE 1

In the embodiment shown in the drawing, the hexamethylenediamine salt of adipic acid (AH salt) and lactam are reacted to give copolyamide. Aqueous AH salt and lactam are passed via, in each case, a preheater 1a, 1b into a pressure reactor 2. Optionally, stabilizers and other additives are metered in after the preheating.

For a special product, 3100 g/h of an aqueous AH salt solution and 9800 g of caprolactam/h are metered. On average, the weight ratio of AH salt to caprolactam was 20%. The system temperature in the pressure reactor was 265° C.

The gas space of the pressure reactor 2 is connected via a reflux column 7 and a pressure controller 10 to the gas space of a postcondensation reactor 5.

A pressure of 10 bar (gauge pressure) was set at the pressure controller 10. A heating element 5.1 which promotes the expulsion of water is installed at the top of the postcondensation reactor 5, slightly below the product surface.

The reflux column 7 upstream of the pressure controller 10 is required for ensuring that the reaction proceeds uniformly in the pressure reactor 2. The low-viscosity polymer prepared in the pressure reactor 2 is passed into the postcondensation reactor 5 via a pump 3 with level control and via a melt dryer 4. The postcondensation reactor 5 can also be kept under slightly superatmospheric pressure up to 2 bar by means of a further pressure controller 11. This is expedient in particular with the use of a high percentage of 80% or more of AH salt in the starting monomer and low target viscosity, as required as a starting material for textile silk production.

In the melt dryer 4, the prepolymer is heated to 280° C., at the same time the water present in excess being evaporated. This prepolymer is let down to atmospheric pressure in the postcondensation reactor 5, the prepolymer being passed via a devolatilization surface and the heat exchanger 5.1 present below the melt level, for better expulsion of water in vapor form. The excess water is removed from the process with pressure control via a reflux column 8 and a trap 9.

The product residence time in the postcondensation reactor 5 is, for example, 5 hours. Separation of the gas mixture is effected in the reflux column 8. The ε-caprolactam runs back into the postcondensation reactor. The water leaves the polymerization process.

For expelling this water, hot nitrogen is passed into the postcondensation reactor 5 so that water can readily diffuse out of the PA melt. This nitrogen and the water are removed from the process via the trap 9. Heating of the nitrogen prior to entry into the postcondensation reactor is particularly advantageous. This is not shown in the figure.

Copolyamide having an average melting point of 189° C. and a solution viscosity, measured in 98% strength sulfuric acid, of 2.7 was produced.

The temperature level for the separation in the reflux column 8 can be substantially reduced compared with known methods in which an additional reflux column at a first pressure reactor is absolutely essential, namely to at least 100° C., with the result that diamine losses are substantially reduced.

The total extract after the postcondensation reactor 5 was 7.8%. The material was then extracted and dried.

### WORKING EXAMPLE 2

For the preparation of PA66, an aqueous AH salt solution was preheated to >220° C. in the preheater 1b, water also being evaporated in the preheater. The system temperature in the pressure reactor 2 was 265° C. and the product residence time was 1 hour.

The polyamide 66 was fed into the postcondensation reactor 5 via the pump 3 and the melt dryer 4. The product residence time was 3 hours. The polyamide 66 was metered to the granulation process via the pump 6.

A pressure of 22 bar was set in the pressure reactor 2. Water and amine were passed into the gas space of the postcondensation reactor 5 via the reflux column 7 and the pressure controller 10. Devolatilization was effected from the postcondensation reactor 5 via the reflux column 8 and the pressure controller 11 into the trap 9. 0.3 bar was set at the pressure controller 11. The gas space of the postcondensation reactor was rendered inert with nitrogen. Polyamide 66 having a viscosity in solution viscosity units of 2.2 was prepared.

1. A method for the continuous production of copolyamide and polyamide, the starting material of which consists of the salt of hexamethylenediamine with adipic acid (AH salt) and water and, in the case of copolyamide, additionally of lactam, comprising a first stage of the method, which is carried out under pressure at temperatures between 180 and 280° C., the prepolymer being fed, after passing through the first stage of the method, to at least one further stage of the method, from which the evaporated water is removed and/or is expelled with inert gas, characterized in that the water evaporating in the first stage of the method, with reaction components contained therein, is passed into the at least one further stage of the method and the expulsion of the water is effected only in the further stage or stages of the method.

2. The method as claimed in claim 1, characterized in that the water evaporating in the first stage of the method, with reaction components contained therein, is passed into the at least one further stage of the method, from which the waste product in vapor form is passed via a reflux column outside the limit of the method and/or into the gas space of the next stage of the method.

3. The method as claimed in claim 1, characterized in that an amount of AH-salt of up to 30% or from 80 to 100% is used.

4. The method as claimed in claim 1, characterized in that the expulsion of the water in the reflux column is effected at a temperature, at the upper end of the reflux column, of less than 120° C., and in that caprolactam and diamine fractions separated off in the reflux column are recycled to the at least one further stage of the method.

5. Device for carrying out the method as claimed in any of the preceding claims, comprising a first pressure reactor (2), upstream of which a heat exchanger (1) is connected and downstream of which at least one postcondensation reactor (5) is connected via a melt dryer (4), characterized in that the gas space of the pressure reactor (2) is connected with pressure control to the gas space of the postcondensation reactor (5), and in that water from the gas space of the postcondensation reactor (5) is expelled via a reflux column (8) and a trap (9).

6. The device as claimed in claim 5, characterized in that, in the reflux column (8), the caprolactam and diamine fractions separated off are recycled to the postcondensation reactor (5).

7. The device as claimed in claim 5, characterized in that the separation in the reflux column (8) is effected at a temperature of less than 120° C.
